(19) United States
(12) Patent Application Publication
(10) Pub. No.: US 2018/0141851 A1
(43) Pub. Date: May 24, 2018

(54) OPTICAL GLASS AND OPTICAL COMPONENT

(71) Applicant: ASAHI GLASS COMPANY, LIMITED, Chiyoda-ku (JP)

(72) Inventors: Shin-ichi Amma, Chiyoda-ku (JP); Tatsuo Nagashima, Chiyoda-ku (JP); Shusaku Akiba, Chiyoda-ku (JP)

(73) Assignee: ASAHI GLASS COMPANY, LIMITED, Chiyoda-ku (JP)

(21) Appl. No.: 15/861,122

(22) Filed: Jan. 3, 2018

Related U.S. Application Data
(63) Continuation of application No. PCT/JP2017/026639, filed on Jul. 24, 2017.

(30) Foreign Application Priority Data
Jul. 28, 2016 (JP) 2016-148683
Jan. 20, 2017 (JP) 2017-008713

(51) Int. Cl. C03C 3/097; C03C 3/064; C03C 3/066; C03C 3/068; C03C 3/062; C03C 4/20; G02B 3/00

(52) U.S. Cl. CPC C03C 3/097; C03C 3/064; C03C 3/066; C03C 3/068; G02B 1/11; C03C 4/20; G02B 3/00; C03C 2204/00; C03C 3/062

(57) ABSTRACT

Provided is an optical glass having a high refractive index, a low density, and good manufacturing properties. An optical glass having: a refractive index (n_{d}) of 1.68 to 1.85; a density (d) of 4.0 g/cm³ or less; and a temperature where a viscosity of glass becomes log η=2 of 950 to 1200° C., and an optical component using the optical glass are provided. This optical glass has the high refractive index, the low density, and the good manufacturing properties, and is suitable as the optical glass of wearable equipment, for a vehicle mounting, for a robot mounting, and so on.

### CROSS-REFERENCE TO RELATED APPLICATIONS

This application is a continuation of prior International Application No. PCT/JP2017/026639, filed on Jul. 24, 2017 which is based upon and claims the benefit of priority from Japanese Patent Applications No. 2016-148683 filed on Jul. 28, 2016, and No. 2017-008713 filed on Jan. 20, 2017; the entire contents of all of which are incorporated herein by reference.

### FIELD

The present invention relates to an optical glass and an optical component.

### BACKGROUND

High refractive index is required for glass used for wearable equipment such as, for example, glasses with projector, a glasses-type or goggle-type display, a virtual reality and augmented reality display device, and a virtual image display device from viewpoints of enabling high-angle, high-luminance and high-contrast image, improvement in light guide properties, process easiness of diffraction grating, and so on. Conventionally, a small-sized imaging glass lens with a wide imaging angle of view has been used for purposes such as a vehicle-mounted camera and a robot's visual sensor, and a high refractive index is required for the imaging glass lens as above in order to photograph a wider range with a smaller lens.

As optical glass used for the above purposes, it is required that a density thereof is low so as to enable desirable wearing feeling for a user, and to reduce a weight of a device as a whole because a vehicle and a robot is required to reduce its weight. Further, it is also important that there are less surface deterioration and alteration due to acid rain and chemicals such as detergent and wax used for washing in consideration of use in an external environment.

Regarding a vehicle-mounted glass lens among the above, it has been attempted to increase refractive index and strength, and further to improve acid resistance and water resistance by using, for example, a lens glass material for a vehicle-mounted camera with predetermined acid resistance (refer to JP-A 2013-256446 (KOKAI), for example).

### SUMMARY

However, conventionally, it is often the case that heavy metal oxides are used as a glass component increasing the refractive index in order to have a high refractive-index composition. As a result, a density of a high-refractive-index glass generally becomes large.

There is a case when glass molded into a plate shape is used for wearable equipment, and it is sometimes fabricated by a molding method such as a float method, a fusion method, and a roll-out method whose manufacturing efficiency is high. In this case, a relationship between a temperature and a viscosity of glass at the time of manufacturing is important to efficiently manufacture.

When the glass is used as an optical component, visible light transmittance is also an important parameter. In case of the high-refractive-index glass, there is a possibility that visible light transmittance particularly on a short wavelength side is lowered when it is melted at a high temperature. On the other hand, when a viscosity curve is steep, control of the viscosity at the time of manufacturing becomes difficult.

The present invention is made to solve the above-stated problems, and an object thereof is to provide an optical glass which has a high refractive index and a low density, and excellent manufacturing properties.

An optical glass of the present invention is characterized in that it has: a refractive index (n_{d}) of 1.68 to 1.85, a density of 4.0 g/cm³ or less, and a temperature T₂ where a viscosity of glass becomes log η=2 is 950 to 1200° C.

An optical component of the present invention is characterized in that it uses the optical glass of the present invention.

### BRIEF DESCRIPTION OF THE DRAWINGS

FIG. 1 is a sectional view to explain warpage of an optical glass

### DETAILED DESCRIPTION

Hereinafter, embodiments of an optical glass and an optical component according to the present invention are described.

An optical glass of the embodiment has a predetermined refractive index (n_{d}), a density (d) and melting properties as above, and these properties are described in sequence. The optical glass of this embodiment has the high refractive index (n_{d}) in a range of 1.68 to 1.85. Since the refractive index (n_{d}) is 1.68 or more, the optical glass of this embodiment is suitable as an optical glass—used for wearable equipment in viewpoints of enabling high-angle, high-luminance and high-contrast image, improvement in light guide properties, process easiness of diffraction grating, and so on. The optical glass of this embodiment is also suitable as a small-sized imaging glass lens with wide imaging angle of view used for purposes such as a vehicle-mounted camera and a robot's visual sensor because wider range can be photographed with a small-sized lens. The refractive index (n_{d}) is preferably 1.70 or more, more preferably 1.73 or more, further preferably 1.74 or more, and still further preferably 1.75 or more.

On the other hand, when the refractive index (n_{d}) exceeds 1.85, there is a tendency that the density of the glass is likely to increase, and a devitrification temperature is likely to increase. The refractive index (n_{d}) is preferably 1.83 or less, more preferably 1.82 or less, further preferably 1.81 or less, and still further preferably 1.80 or less.

The optical glass of this embodiment has the density (d) of 4.0 g/cm³ or less. The optical glass of this embodiment has the density of the above-stated range, and thereby, it is possible to enable preferable wearing feeling for a user when it is used for wearable equipment, and to reduce a weight of a device as a whole when it is used for a vehicle-mounted camera, a robot's visual sensor, and so on. The density (d) is preferably 3.8 g/cm³ or less, more preferably 3.6 g/cm³ or less, further preferably 3.5 g/cm³ or less, and still further preferably 3.4 g/cm³ or less. On the other hand, in the optical glass of this embodiment, the density (d) is preferably 2.0 g/cm³ or more in order to keep a glass surface away from being scratched. The density (d) is more preferably 2.2 g/cm³ or more, further preferably 2.3 g/cm³ or more, and still further preferably 2.4 g/cm³ or more.

The optical glass of this embodiment has a viscosity of glass in which a temperature T₂ where log η=2 is in a range of 950 to 1200° C. (here, η is a viscosity when a shear stress is “0” (zero)). The T₂ is a reference temperature of meltability, and when the

T₂ of the glass is too high, there is a possibility that visible light transmittance particularly on a short wavelength side is lowered regarding a high-refractive-index glass because it is necessary to melt at high temperature. The T₂ is preferably 1180° C. or less, more preferably 1150° C. or less, further preferably 1130° C. or less, and still further preferably 1110° C. or less.

On the other hand, when the T₂ is too low, there is a problem in which a viscosity curve becomes steep, and control of the viscosity at a manufacturing time becomes difficult. The optical glass of this embodiment has the T₂ in the above range, and thereby, manufacturing properties can be made fine. The T₂ is preferably 970° C. or more, more preferably 990° C. or more, further preferably 1010° C. or more, and still further preferably 1030° C. or more.

The optical glass of this embodiment preferably has the devitrification temperature of 1200° C. or less. This property enables to suppress devitrification of the glass at molding time, and moldability thereof becomes good. The devitrification temperature is more preferably 1175° C. or less, further preferably 1150° C. or less, still further preferably 1125° C. or less, and particularly preferably 1100° C. or less. Here, the devitrification temperature is the lowest temperature where no crystal with a size of 1 or more in a long edge or a major axis is found at a surface and an inside of glass when glass heated to be melted is left standing to cool naturally.

In the wearable equipment, it is required to suppress lowering of transmittance of visible light obtained through the optical glass, but there is a case in the glass of this embodiment in which the transmittance is lowered on a wavelength side shorter than 400 nm due to melting at high temperature. In the vehicle-mounted camera and the robot's visual sensor, there is a case when a near-ultraviolet image is used to recognize an object which is difficult to be discriminated in visible light, and high transmittance in a near-ultraviolet range is required for the glass used for the optical system. Accordingly, the optical glass of this embodiment preferably has transmittance of light with a wavelength of 360 nm (T₃₆₀) of 40% or more of a glass plate made of the optical glass with a thickness of 1 mm. The glass having the property as above is suitable as glass used for the wearable equipment and the vehicle-mounted camera. In particular, in a light guide which displays images and video in the wearable equipment, a light intensity loss on a short wavelength side becomes large because an optical path length to be wave-guided becomes long. In this embodiment, since the transmittance on the short wavelength side is as high as 40% or more, the light intensity loss on the short wavelength side as above is suppressed. Accordingly, it becomes easy to reproduce a desired color without lowering the transmittance in all of a visible range. In addition, lowering of luminance of video and images does not occur. The T₃₆₀ is more preferably 50% or more, further preferably 60% or more, still further preferably 65% or more, and particularly preferably 70% or more. The T₃₆₀ can be measured by using a spectrophotometer regarding, for example, a glass plate with a thickness of 1 mm whose both surfaces are mirror-polished.

In the optical glass of this embodiment, Young's modulus (E) is preferably 60 GPa or more. This property offers an advantage that there is less deflection when the optical glass is used for the wearable equipment as a thin glass plate and used for the vehicle-mounted camera, the robot's visual sensor, or the like as a lens. In particular, it is possible to prevent a ghost phenomenon and distortion of images and video in case of the light guide when it is attached to a frame of glasses or a display device. The E is more preferably 70 GPa or more, further preferably 80 GPa or more, still further preferably 85 GPa or more, and particularly preferably 90 GPa or more.

In the optical glass of this embodiment, water resistance (RW) measured based on Japanese Optical Glass Industrial Standard JOGIS06-2008: the measuring method for chemical durability of optical glass (powder method) is preferably Class 2 or higher. Concretely, the RW is measured as described below. A mass decrease rate (%) is measured when glass powder with a particle size of 420 to 600 μm is immersed in 80 mL of pure water at 100° C. for one hour. A predetermined class is supplied according to the mass decrease rate. As a numeric value of the class is smaller, the RW is better.

In the optical glass of this embodiment, acid resistance (RA) measured based on JOGIS06-2008: the measuring method for chemical durability of optical glass (powder method) is preferably Class 1 or higher. Concretely, the RA is measured as described below. A mass decrease rate (%) is measured when glass powder with a particle size of 420 to 600 μm is immersed in 80 mL of 0.01 normal aqueous solution of nitric acid at 100° C. for one hour. A predetermined class is supplied according to the mass decrease rate. As a numeric value of the class is smaller, the RA is better.

The optical glass of this embodiment preferably has a glass transition point (Tg) in a range of 500 to 700° C. The optical glass of this embodiment has the Tg in the above range, and thereby, moldability in a press forming and a redraw forming becomes good. The Tg is more preferably 520° C. to 680° C., further preferably 540° C. to 660° C., still further preferably 560° C. to 640° C., and particularly preferably 570° C. to 620° C. The Tg can be measured by, for example, a thermal expansion method.

The optical glass of this embodiment preferably has an Abbe number (v_{d}) of 50 or less. Concretely, when the optical glass of this embodiment is applied to a glass plate such as the light guide, the low v_{d} in the above range enables to easily perform optical design of the wearable equipment, and also to improve chromatic aberration, and therefore, beautiful images and video can be reproduced. The v_{d} is more preferably 46 or less, further preferably 42 or less, still further preferably 38 or less, and particularly preferably 34 or less.

A lower limit of the Abbe number of the optical glass of this embodiment is not particularly limited, but it is often approximately 10 or more, concretely 15 or more, and more concretely 20 or more.

In the optical glass of this embodiment, a thermal expansion coefficient (α) at 50 to 350° C. is preferably in a range of 50 to 150 (×10⁻⁷/K). The optical glass of this embodiment has the a in the above range, and thereby, expansion matching with peripheral members becomes good. The a is more preferably 60 to 135 (×10⁻⁷/K), further preferably 70 to 120 (×10⁻⁷/K), still further preferably 80 to 105 (×10⁻⁷/K), and particularly preferably 90 to 100 (×10⁻⁷/K).

The optical glass of this embodiment is preferably a glass plate with a thickness of 0.01 to 2.0 mm. The thickness is 0.01 mm or more, and thereby, breakage due to handling or processing of the optical glass can be suppressed. In addition, deflection due to the own weight of the optical glass can be suppressed. The thickness is more preferably 0.1 mm or more, further preferably 0.3 mm or more, and still further preferably 0.5 mm or more. On the other hand, when the thickness is 2.0 mm or less, an optical element using the optical glass can be reduced in weight. The thickness is more preferably 1.5 mm or less, further preferably 1.0 mm or less, and still further preferably 0.8 mm or less.

When the optical glass of this embodiment is a glass plate, an area of one principal surface is preferably 8 cm² or more. When the area is 8 cm² or more, a lot of optical elements can be disposed to improve productivity. The area is more preferably 30 cm² or more, further preferably 170 cm² or more, still further preferably 300 cm² or more, and particularly preferably 1000 cm² or more. On the other hand, when the area is 6500 cm² or less, handling of the glass plate becomes easy, and the breakage due to handling or processing of the glass plate can be suppressed. The area is more preferably 4500 cm² or less, further preferably 4000 cm² or less, still further preferably 3000 cm² or less, and particularly preferably 2000 cm² or less.

When the optical glass of this embodiment is the glass plate, a local thickness variation (LTV) in 25 cm² of one principal surface is preferably 2 μm or less. Flatness in this range enables to form a nanostructure with a desired shape on one principal surface by using an imprint technology or the like, and to obtain desired light guide properties. In particular, a ghost phenomenon and distortion due to a difference in optical lengths can be prevented in the light guide. The LTV is more preferably 1.8 μor less, further preferably 1.6 μm or less, still further preferably 1.4 μor less, and particularly preferably 1.2 μm or less.

When the optical glass of this embodiment is a circular glass plate with a diameter of 8 inches, warpage thereof is preferably 50 μm or less. When the warpage of the glass plate is 50 μm or less, the nanostructure in the desired shape can be formed on one principal surface by using the imprint technology or the like, and to obtain the desired light guide properties. In addition, a plurality of light guides with stable quality can be obtained. The warpage of the glass plate is more preferably 40 μm or less, further preferably 30 μm or less, and particularly preferably 20 μor less.

When the optical glass of this embodiment is a circular glass plate with a diameter of 6 inches, the warpage thereof is preferably 30 μm or less. When the warpage of the glass plate is 30 μor less, the nanostructure in the desired shape can be formed on one principal surface by using the imprint technology or the like, and to obtain the desired light guide properties. In addition, the plurality of light guides with stable quality can be obtained. The warpage of the glass plate is more preferably 20 μm or less, further preferably 15 μm or less, and particularly preferably 10 μm or less.

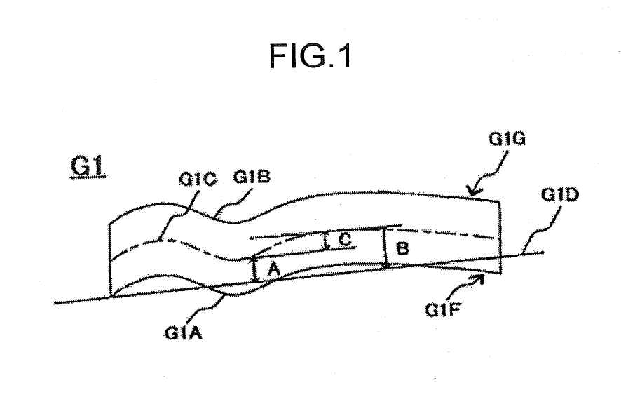

FIG. 1 is a sectional view when the optical glass of this embodiment is a glass plate G1. “Warpage” is a difference C between a maximum value B and a minimum value A of a distance between a reference line G1D of the glass plate G1 and a center line G1C of the glass plate G1 in a vertical direction at an arbitrary cross-section which passes a center of one principal surface G1F of the glass plate G1 and is orthogonal to one principal surface G1F of the glass plate G1.

An intersection line between the orthogonal arbitrary cross-section and one principal surface G1F of the glass plate G1 is set as a base line G1A. An intersection line between the orthogonal arbitrary cross-section and the other principal surface GIG of the glass plate G1 is set as an upper line G1B. Here, the center line G1C is a line connecting each center in a plate thickness direction of the glass plate G1. The center line G1C is calculated by finding a midpoint between the base line G1A and the upper line G1B with. respect to a later-described laser irradiation direction.

The reference line G1D is found as described below. First, the base line G1A is calculated based on a measuring method in which effect due to its own weight is canceled. A straight line is found by a least squares method from the base line G1A. The found straight line is the reference line G1D. A publicly known method is used as the measuring method in which the effect due to its own weight is canceled.

For example, one principal surface G1F of the glass plate G1 is three-point supported, then laser is irradiated on the glass plate G1 by a laser displacement gauge, and there are measure heights of one principal surface G1F and the other principal surface G1G of the glass plate G1 from an arbitrary reference plane.

Next, the glass plate G1 is reversed, then three points of the other principal surface G1G opposing to the three points which have supported one principal surface G1F are supported, and there are measured the heights of one principal surface G1F and the other principal surface G1G of the glass plate G1 from the arbitrary reference plane. Averages of heights at respective measurement points before and after the reverse are found, and thereby, the effect due to its own weight is canceled. For example, the height of one principal surface G1F is measured before the reverse as described above. After the glass plate G1 is reversed, the height of the other principal surface G1G is measured at a position corresponding to the measurement point of one principal surface G1F. Similarly, the height of the other principal surface G1G is measured before the reverse. After the glass plate G1 is reversed, the height of one principal surface G1F is measured at a position corresponding to the measurement point of the other principal surface G1G. Warpage is measured by, for example, the laser displacement gauge.

In the optical glass of this embodiment, surface roughness Ra of one principal surface is preferably 2 nm or less. The Ra in this range enables to form the nanostructure with the desired shape on one principal surface by using the imprint technology or the like, and to obtain the desired light guide properties. In particular, irregular reflection at an interface is suppressed in the light guide, and the ghost phenomenon and distortion can be prevented. The Ra is more preferably 1.7 nm or less, further preferably 1.4 nm or less, still further preferably 1.2 nm or less, and particularly preferably 1 nm or less. The surface roughness Ra is arithmetic mean roughness defined in JIS B0601 (2001). In this specification, it is a value obtained by measuring an area of 10 μm×10 μm by using an atomic force microscope (AFM).

[Glass Component]

Next, an embodiment of a composition range of each component which can be contained by the optical glass of this embodiment is described in detail. In this specification, a content rate of each component is represented % by mass with respect to all the mass of the glass based on oxides unless otherwise specified. In the optical glass of this embodiment, “substantially not contained” means that the component is not contained except for inevitable impurities. A content of inevitable impurities is 0.1% or less in this embodiment.

As a composition satisfying the above properties in the optical glass of this embodiment, for example, there can be cited, in % by mass display based on oxides, the composition containing Nb₂O₅: 5% to 55%, 0% to 30% of at least one kind selected from a group consisting of BaO, TiO₂, ZrO₂, WO₃, and Ln₂O₃ (where Ln is at least one kind selected from a group consisting of Y, La, Gd, Yb and Lu), SiO₂: 29% to 50%, where Li₂O+Na₂O+K₂O is 2% to 20%, and Li₂O/(Li₂O+Na₂O+K₂O) is 0.45 or less. Other components can be contained according to need. A total amount of alkali metal oxide components of at least one kind selected from a group consisting of Li₂O, Na₂O and K₂O is represented by “Li₂O+Na₂O+K₂O”.

Each component in this glass composition is concretely described below. Note that the optical glass of this embodiment is not limited to the composition of the following embodiments as long as the above properties are included.

SiO₂ is a glass forming component, and is a component supplying high strength and crack resistance to the glass, and improving stability and chemical durability of the glass. The content rate of SiO₂ is 29% or more and 50% or less. When the content rate of SiO₂ is 29% or more, the temperature T₂ where the viscosity of the glass becomes log η=2 can fall within a preferable range. On the other hand, when the content rate of SiO₂ is 50% or less, a component to obtain a high refractive index can be contained. The content rate of SiO₂ is preferably 31% or more, more preferably 32% or more, further preferably 33% or more, and particularly preferably 35% or more. The content rate of SiO₂ is preferably 45% or less, more preferably 42% or less, and further preferably 40% or less.

Nb₂O₅ is a component increasing the refractive index of the glass, and decreasing the Abbe number (v_{d}). The content rate of Nb₂O₅ is 5% or more and 55% or less. When the content rate of Nb₂O₅ is 5% or more, a high refractive index can be obtained. The content raten of Nb₂O₅ is preferably 15% or more, more preferably 25% or more, further preferably 35% or more, and particularly preferably 40% or more. When Nb₂O₅ is contained too much, devitrification is likely to occur. Accordingly, the content rate is preferably 55% or less, more preferably 52% or less, and further preferably 49% or less.

BaO, TiO₂, ZrO₂, WO₃, and Ln₂O₃ (where Ln is at least one kind selected from the group consisting of Y, La, Gd, Yb and Lu) are components increasing the refractive index of the glass. A total content rate of these components is 0% or more and 30% or less.

When the content rate of Nb₂O₅ is 15% or less, it is preferable that 1% or more of at least one kind selected from the group consisting of BaO, TiO₂, ZrO₂, WO₃, and Ln₂O₃ (where Ln is at least one kind selected from the group consisting of Y, La, Gd, Yb and Lu) is contained as other high-refractive-index components together with Nb₂O₅ to increase the refractive index of the glass. The content rate of these components is more preferably 3% or more, further preferably 5% or more, and particularly preferably 7% or more. On the other hand, when the content rate of the other high-refractive-index components is over 30%, the devitrification is likely to occur. The content rate of these components is more preferably 25% or less, further preferably 20% or less, and particularly preferably 15% or less.

In the optical glass of this embodiment, alkali metal components (Li₂O+Na₂O+K₂O) are contained, where the Tg can be lowered by increasing the total amount of the alkali metal components. However, when the amount of Li₂O+Na₂O+K₂O is too much, the T₂ is likely to be low, a viscosity curve becomes steep to lower manufacturing properties. On the other hand, when the amount of Li₂O+Na₂O+K₂O is too small, the T₂ is likely to be high, a melting temperature becomes high, and there is a possibility of being colored. Accordingly, Li₂O+Na₂O+K₂O is to be contained 2% or more and 20% or less. The amount of Li₂O+Na₂O+K₂O is preferably 4% or more, more preferably 6% or more, further preferably 8% or more, and particularly preferably 10% or more. The amount of Li₂O+Na₂O+K₂O is preferably 18% or less, more preferably 16% or less, further preferably 14% or less, and particularly preferably 12% or less.

In the optical glass of this embodiment, among the alkali metal components (Li₂O, Na₂O, K₂O), Li₂O is a component improving strength of the glass, but when an amount of Li₂O is too much, the T₂ is likely to be low, and the devitrification is likely to occur. Accordingly, in the optical glass of this embodiment, a value of a rate in % by mass based on oxides of Li₂O/(Li₂O+Na₂O+K₂O) is 0.45 or less. When Li₂O/(Li₂O+Na₂O+K₂O) is over 0.45, the T₂ is likely to be low, the devitrification is likely to occur, and easy moldability of the glass is deteriorated. Li₂O/(Li₂O+Na₂O+K₂O) is more preferably 0.4 or less, further preferably 0.35 or less, and particularly preferably 0.3 or less.

Li₂O is an optional component, and is a component improving the strength of the glass, lowering the T₂, lowering the Tg, and improving meltability of the glass. A content rate of Li₂O is 0% or more and 9% or less. When Li₂O is contained, it is possible to improve strength (Kc) and crack resistance (CIL). On the other hand, when the amount of Li₂O is too much, the devitrification is likely to occur. When the optical glass of this embodiment contains Li₂O, the content rate is preferably 0.5% or more, more preferably 1% or more, further preferably 2% or more, and particularly preferably 3% or more. The content rate of Li₂O is preferably 8% or less, more preferably 7% or less, further preferably 6% or less, and particularly preferably 5% or less.

When the optical glass of this embodiment is chemically tempered, the content rate of Li₂O is preferably 1.0% or more, more preferably 1.5% or more, further preferably 2.5% or more, and particularly preferably 3.5% or more.

Na₂O is an optional component, and is a component suppressing the devitrification and lowering the Tg. A content rate of Na₂O is 0% or more and 10% or less. When Na₂O is contained, an excellent devitrification suppression effect can be obtained. On the other hand, when an amount of Na₂O is too much, the strength and the crack resistance are likely to be lowered. When the optical glass of this embodiment contains Na₂O, the content rate is preferably 0.5% or more, more preferably 1% or more, further preferably 2% or more, and particularly preferably 3% or more. The content rate of Na₂O is preferably 9% or less, more preferably 8% or less, and further preferably 7% or less.

When the optical glass of this embodiment is chemically tempered, the content rate of Na₂O is preferably 1.0% or more, more preferably 1.5% or more, further preferably 2.5% or more, and particularly preferably 3.5% or more.

K₂O is an optional component, and is a component improving meltability of the glass and suppressing the devitrification. A content rate of K₂O is 0% or more and 10% or less. When K₂O is contained, the devitrification suppression effect is improved. On the other hand, when an amount of K₂O is too much, a density is likely to increase. The content rate of K₂O is preferably 0.3% or more, more preferably 0.5% or more, and further preferably 1% or more. The content rate of K₂O is preferably 10% or less, more preferably 8% or less, and further preferably 6% or less.

B₂O₃ is an optional component. B₂O₃ is a component lowering the Tg, and improving mechanical properties such as the strength and the crack resistance of the glass. However, when an amount of B₂O₃ is too much, the refractive index is likely to be lowered. Accordingly, a content rate of B₂O₃ is preferably 0% or more and 10% or less. The content rate of B₂O₃ is more preferably 8.5% or less, further preferably 6.5% or less, and particularly preferably 5% or less. The content rate of B₂O₃ is more preferably 0.3% or more, further preferably 0.5% or more, and particularly preferably 1% or more.

MgO is an optional component. MgO is a component improving the meltability of the glass, suppressing the devitrification, and adjusting optical constants such as the Abbe number and the refractive index of the glass. On the other hand, when an amount of MgO is too much, the devitrification is conversely accelerated. Accordingly, a content rate of MgO is preferably 0% or more and 10% or less. The content rate of MgO is more preferably 8% or less, and particularly preferably 6% or less. The content rate of MgO is more preferably 0.3% or more, further preferably 0.5% or more, and still further preferably 1% or more.

CaO is an optional component. CaO is a component suppressing the devitrification, but when an amount of CaO is too much, the crack resistance is likely to be lowered. Accordingly, a content rate of CaO is preferably 0% or more and 15% or less. The content rate of CaO is more preferably 12% or less, and particularly preferably 10% or less. The content rate of CaO is more preferably 0.3% or more, further preferably 0.5% or more, and particularly preferably 1% or more.

SrO is an optional component. SrO is a component improving the meltability of the glass, suppressing the devitrification, and adjusting the optical constants of the glass. On the other hand, when an amount of SrO is too much, the devitrification is conversely accelerated. Accordingly, a content rate of SrO is preferably 0% or more and 15% or less. The content rate of SrO is more preferably 12% or less, and particularly preferably 10% or less. The content rate of SrO is more preferably 0.3% or more, further preferably 0.5% or more, and particularly preferably 1% or more.

BaO is an optional component. BaO is a component suppressing the devitrification, but when an amount of BaO is too much, the density is likely to be large. Accordingly, a content rate of BaO is preferably 0% or more and 15% or less when it is contained. The content rate of BaO is more preferably 10% or less, further preferably 8% or less, and particularly preferably 6% or less. The content rate of BaO is more preferably 0.3% or more, further preferably 0.5% or more, and particularly preferably 1% or more.

Al₂O₃ is an optional component. Al₂O₃ is a component improving the chemical durability. However, when an amount of Al₂O₃ is too much, the glass is likely to be devitrified. Accordingly, a content rate of Al₂O₃ is preferably 0% or more and 5% or less. The content rate of Al₂O₃ is more preferably 3% or less, and particularly preferably 2% or less. The content rate of Al₂O₃ is more preferably 0.3% or more, further preferably 0.5% or more, and particularly preferably 1% or more.

TiO₂ is an optional component, and is a component increasing the refractive index of the glass, and enlarging dispersion of the glass. When TiO₂ is contained, it is possible to improve the refractive index. On the other hand, when an amount of TiO₂ is too much, the glass is likely to be colored and transmittance is lowered. Accordingly, a content rate of TiO₂ is preferably 0% or more and 15% or less. When TiO₂ is contained, the content rate is more preferably 0.5% or more, further preferably 1% or more, and particularly preferably 1.5% or more. The content rate of TiO₂ is more preferably 12% or less, further preferably 10% or less, and particularly preferably 8% or less.

WO₃ is an optional component. When WO₃ is added, the devitrification of the glass is suppressed, but when an amount of WO₃ is too much, the glass is conversely likely to be devitrified. Accordingly, a content rate of WO₃ is preferably 0% or more and 15% or less. The content rate of WO₃ is more preferably 12% or less, further preferably 9% or less, and particularly preferably 5% or less. The content rate of WO₃ is more preferably 0.3% or more, further preferably 0.5% or more, and particularly preferably 1% or more.

ZrO₂ is an optional component, and is a component increasing the refractive index of the glass and increasing the chemical durability of the glass. When ZrO₂ is contained, it is possible to improve the crack resistance. On the other hand, when an amount of ZrO₂ is too much, the devitrification is likely to occur. Accordingly, a content rate of ZrO₂ is preferably 0% or more and 15% or less. When ZrO₂ is contained, the content rate is more preferably 0.5% or more, further preferably 1% or more, and particularly preferably 2% or more. The content rate of ZrO₂ is more preferably 15% or less, further preferably 12% or less, and particularly preferably 10% or less.

ZnO is an optional component, and is a component improving the mechanical properties such as the strength and the crack resistance of the glass. On the other hand, when an amount of ZnO is too much, the devitrification is likely to occur. Accordingly, a content rate of ZnO is preferably 0% or more and 15% or less. The content rate of ZnO is more preferably 13% or less, further preferably 12% or less, and particularly preferably 10% or less. The content rate of ZnO is more preferably 0.3% or more, further preferably 0.5% or more, and particularly preferably 1% or more.

La₂O₃ is an optional component. La₂O₃ is a component improving the refractive index of the glass. However, when an amount of La₂O₃ is too much, the mechanical properties are lowered. Accordingly, a content rate of La₂O₃ is preferably 0% or more and 12% or less. The content rate of La₂O₃ is more preferably 10% or less, and further preferably 8% or less. La₂O₃ is preferably substantially not contained.

Ln₂O₃ (where Ln is at least one kind selected from the group consisting of Y, La, Gd, Yb and Lu) improves the refractive index of the glass. On the other hand, when an amount of Ln₂O₃ is too much, the dispersion of the glass is lowered, and the devitrification is likely to occur. Accordingly; Ln₂O₃ is preferably 15% or less in total, more preferably 10% or less, and particularly preferably 7% or less. Ln₂O₃ is preferably substantially not contained.

As₂O₃ is a noxious chemical substance, and therefore, there is a tendency to refrain from using As₂O₃ in recent years, and environmental measures are required to be taken. Accordingly, As₂O₃ is preferably substantially not contained except for inevitable mixing when environmental effects are attached importance.

In the optical glass of this embodiment, it is preferable that at least one of Sb₂O₃ and SnO₂ is contained. They are not essential components, but can be added for the purposes of adjustment of refractive-index properties, improvement in meltability, suppression of coloring, improvement in transmittance, improvement in clarifying and chemical durability, and so on. When these components are contained, a content rate is preferably 10% or less in total, more preferably 5% or less, further preferably 3% or less, and particularly preferably 1% or less.

It is preferable that F is further contained in the optical glass of this embodiment. F is not essential, but can be added for the purposes of improvement in meltability, improvement in transmittance, improvement in clarifying, and so on. When F is contained, a content rate is preferably 5% or less, and more preferably 3% or less.

In the optical glass of this embodiment, the glass containing alkali metal oxides such as Li₂O and Na₂O is able to be chemically tempered by exchanging L₁ ions into Na ions or K ions, and Na ions into K ions. That is, chemical tempering treatment enables to improve the strength of the optical glass.

[Manufacturing Method of Optical Glass and Glass Molded Product]

The optical glass of this embodiment is manufactured as described below, for example. That is, first, raw materials are weighted to be the above-described predetermined glass composition, and they are uniformly mixed. The fabricated mixture is put into a platinum crucible, a quartz crucible or an alumina crucible to be roughly melted. After that, the resultant is put into a gold crucible, the platinum crucible, a platinum alloy crucible, a reinforced platinum crucible or an iridium crucible to be melted at a temperature range of 1200 to 1400° C. for two to 10 hours, it is homogenized by performing deaeration, stirring, and so on to be defoamed or the like, and thereafter, it is casted into a metal mold to be slowly cooled. The optical glass of this embodiment is thereby obtained.

In addition, the optical glass may be made into a glass plate by molding the molten glass into a plate shape by a molding method such as a float method, a fusion method, and a roll-out method. For example, a glass molded product can be fabricated by using means such as a reheat press molding and a precise press molding. That is, a lens preform for a mold-press molding is fabricated from the optical glass, this lens preform is subjected to polishing after the reheat press molding to thereby fabricate the glass molded product, or for example, the lens preform fabricated by polishing is subjected to the precise press molding to fabricate the glass molded product. A means to fabricate the glass molded product is not limited to these means.

Residual bubbles of the optical glass of this embodiment manufactured as above preferably exist 10 pieces per 1 kg (10 pieces/kg) or less, more preferably 7 pieces/kg or less, further preferably 5 pieces/kg or less, and particularly preferably 3 pieces/kg or less. When the glass plate is molded according to the above-stated method, the glass plate without bubbles can be efficiently molded when the residual bubbles exist 10 pieces/kg or less. When a diameter of a minimum-sized circle in which the residual bubble is wrapped is set as a size of each residual bubble, the size of each residual bubble is preferably 80 μm or less, more preferably 60 μm or less, further preferably 40 μm or less, and particularly preferably 20 μm or less.

The diameter is set as a length L₁ in a vertical direction of the residual bubble, and a length of a straight line which is perpendicular to the diameter and is a maximum length of the residual bubble is set as a length L₂ in a lateral direction of the residual bubble. When a shape of the residual bubble is represented by an aspect ratio, L₂/L₁ is preferably 0.90 or more, more preferably 0.92 or more, and further preferably 0.95 or more. When the L₂/L₁ is 0.90 or more, the residual bubble is in a state near a perfect circle (perfect sphere) to be able to suppress occurrence of cracks beginning at the residual bubble when the glass plate is produced even when the residual bubbles are contained because the lowering of the strength of the glass is suppressed compared to an elliptical residual bubble. In addition, there is also an effect that anisotropic scattering of light incident on the glass plate can be suppressed compared to the elliptical residual bubble even when the residual bubbles exist in the glass plate. The size and the shape of the residual bubble are obtained from values measured by a laser microscope (manufactured by KEYENCE CORPORATION: VK-X100).

Optical members such as the glass plate and the glass molded product fabricated as above are useful for various optical elements. Among them, they are particularly suitably used for (1) wearable equipment, for example, glasses with projector, a glasses-type or goggle-type display, a light guide used for a virtual reality and augmented reality display device, a virtual image display device and so on, a filter, a lens, and so on, (2) a lens, a cover glass, and so on used for a vehicle-mounted camera, a robots' visual sensor. It is possible to be suitably used for purposes of being exposed to severe environment such as the vehicle-mounted camera. In addition, it is also suitably used for purposes such as an organic EL glass substrate, a wafer level lens array substrate, a lens unit substrate, a lens forming substrate by an etching method, an optical waveguide, and so on.

The optical glass of this embodiment described hereinabove has a high refractive index, a low density, and good manufacturing properties, further it is suitable as an optical glass for the wearable equipment, for vehicle-mounting, and for robot-mounting.

### EXAMPLES

Raw materials were weighted to have chemical compositions (mass % in terms of oxides) listed in Tables 1 to 7. High purity materials used for a normal optical glass such as oxide, hydroxide, carbonate, nitrate, fluoride, and a metaphosphoric acid compound each corresponding to raw materials of each component were selected and used as the raw materials. In Tables, R₂O represents a total amount of content rates of Li₂O, Na₂O, and K₂O.

The weighted raw materials were uniformly mixed, put into a platinum crucible with an internal volume of 300 mL, melted at approximately 1200° C. for about two hours, clarified, stirred, and thereafter, retained at 1200° C. for 0.5 hours, then casted into a rectangular mold with 50 mm in length×100 mm in width which was preheated to approximately 650° C., and it was slowly cooled at about 1° C./min to obtain samples of Examples 1 to 62, 64, to 66. Regarding a glass of Example 63, since the temperature T₂ where the viscosity η becomes log η=2 was as high as 1200° C. or more, a melting temperature was set to 1400° C. so that the glass was sufficiently clarified and homogenized. Examples 1 to 56 are examples, and Examples 57 to 66 are comparative examples.

[Evaluation]

There were measured a refractive index (n_{d}), a density (d), a devitrification temperature, a viscosity (the temperature T₂ where the viscosity η becomes log η=2), transmittance of light with the wavelength of 360 nm when the sample is made into a glass plate with a thickness of 1 mm (T₃₆₀), water resistance (RW), and acid resistance (RA) as described below. Obtained results were also illustrated in Tables 1 to 7.

Refractive index (n_{d}): A sample glass was processed into a triangle-shaped prism with a size of 30 mm on each side, and a thickness of 10 mm, to be measured by a refractometer (manufactured by Kalnew Corporation, device name: KPR-2000).
Density (d): Measurement was performed based on JIS Z8807 (1976, measuring method where weighting is performed in liquid).
Devitrification temperature: About 5 g of a sample was put into a platinum dish, retained at temperatures every 10° C. from 1000° C. to 1400° C. each for one hour and the resultant was naturally cooled, then presence/absence of crystal precipitation was observed by a microscope, and a minimum temperature where a crystal with a size of 1 μm or more in a long edge or a major axis was not recognized was set as the devitrification temperature.

Temperature T₂: A viscosity when a sample was heated was measured by a rotational viscometer and the temperature T₂ (a reference temperature of meltability) where the viscosity η became log η=2 was measured.
Light transmittance (T₃₆₀): Transmittance of light with a wavelength of 360 nm was measured by a spectrophotometer (manufactured by Hitachi High-Technologies Corporation U-4100) regarding a sample processed into a plate shape with a size of 10 mm×30 mm×1 mm in thickness, whose both surfaces were mirror-polished.

Glass transition point (Tg): A value measured by using a differential thermal dilatometer (TMA), and found based on JIS R3103-3 (2001). Young's modulus (E): A plate-shaped sample with a size of 20 mm×20 mm×1 mm was measured by using an ultrasonic precision thickness gauge (manufactured by OLYMPUS Corporation, MODEL 38DL PLUS) (unit: GPa).

Water resistance (RW): Measurement was performed based on JOGIS06-2008: the measuring method for chemical durability of optical glass (powder method). Concretely, a mass decrease rate (%) was measured when glass powder with a particle size of 420 to 600 μm was immersed in 80 mL of pure water at 100° C. for one hour. In case when the mass decrease rate was less than 0.05%, a class was set to 1, in case of 0.05% or more and less than 0.10%, the class was set to 2, in case of 0.10% or more and less than 0.25%, the class was set to 3, in case of 0.25% or more and less than 0.60%, the class was set to 4, in case of 0.60% or more and less than 1.10%, the class was set to 5, and in case of 1.10% or more, the class was set to 6.

Acid resistance (RA): Measurement was performed based on JOGIS06-2008:

the measuring method for chemical durability of optical glass (powder method). Concretely, a mass decrease rate (%) was measured when glass powder with a particle size of 420 to 600 μm was immersed in 80 mL of 0.01 normal aqueous solution of nitric acid at 100° C. for one hour. In case when the mass decrease rate was less than 0.20%, a class was set to 1, in case of 0.20% or more and less than 0.35%, the class was set to 2, in case of 0.35% or more and less than 0.65%, the class was set to 3, in case of 0.65% or more and less than 1.20%, the class was set to 4, in case of 1.20% or more and less than 2.20%, the class was set to 5, and in case of 2.20% or more, the class was set to 6.

LTV: A plate thickness of a glass plate was measured by using a non-contact laser displacement meter (manufactured by KURODA Precision Industries Ltd., NANOMETRO) regarding a plate-shaped sample with a size of 50 mm×50 mm×1 mm at 3 mm intervals, to calculate LTV.
Warpage: Heights of two principal surfaces of a glass plate were measured by using a non-contact laser displacement meter (manufactured by KURODA Precision Industries Ltd., NANOMETRO) regarding disk-shaped samples with a size of 8 inches in diameter x 1 mm, and 6 inches in diameter×1 mm at 3 mm intervals, warpage was calculated by the method described above with reference to FIG. 1.
Surface roughness (Ra): A value obtained by measuring an area of 10 μm×10 μm by using an atomic force microscope (AFM) (manufactured by Oxford Instruments Corporation) regarding a plate-shaped sample with a size of 20 mm×20 mm×1 mm. Abbe number (v_{d}): The sample used for the refractive-index measurement was used, and the Abbe number was calculated by v_{d}=(n_{d}−1)/(n_{F}−n_{C}). Here, n_{d} is a refractive index with respect to a helium d line, n_{F} is a refractive index with respect to a hydrogen F line, and n_{C} is a refractive index with respect to a hydrogen C line. These refractive indexes were also measured by using the above-described refractometer.
Thermal expansion coefficient (α): Linear thermal expansion coefficients in a range of 50 to 350° C. were measured by using a differential thermal dilatometer (TMA), and an average linear thermal expansion coefficient in the range of 50 to 350° C. was found based on JIS R3102 (1995).

TABLE 1-1

| | | | | | | | | | | Exam. |
|---|---|---|---|---|---|---|---|---|---|---|
| | Exam. 1 | Exam. 2 | Exam. 3 | Exam. 4 | Exam. 5 | Exam. 6 | Exam. 7 | Exam. 8 | Exam. 9 | 10 |
| SiO₂ | 33.8 | 33.5 | 34.7 | 33.5 | 32.6 | 34.4 | 32.8 | 33.9 | 34.7 | 35.3 |
| B₂O₃ | 3.4 | 3.4 | 2.3 | 3.4 | 2.2 | 1.8 | 6.9 | 1.8 | 1.9 | 0.7 |
| MgO | | | | | | | | | | |
| CaO | | | | | | | | | | |
| SrO | | | | 2.2 | | | | | 1.7 | |
| BaO | | | | | | | | 4.8 | | |
| Li₂O | 4.9 | 4.2 | 4.3 | 3.8 | 3.5 | 3.5 | 2.7 | 3.2 | 3.1 | 3.5 |
| Na₂O | 5.4 | 6.0 | 6.2 | 5.5 | 5.9 | 5.9 | 4.6 | 5.4 | 5.0 | 5.9 |
| K₂O | 1.0 | 2.0 | 2.1 | 1.9 | 4.0 | 4.0 | 3.1 | 3.6 | 3.3 | 4.0 |
| Al₂O₃ | | | | | 1.6 | | | | | |
| Y₂O₃ | | | | | | | | | | |
| TiO₂ | | | | | | | | | | |
| WO₃ | | 3.7 | 7.8 | 2.5 | | | | | | |
| Nb₂O₅ | 47.5 | 43.0 | 35.6 | 42.8 | 46.1 | 46.5 | 46.0 | 43.2 | 43.0 | 46.5 |
| La₂O₃ | | | | | | | | | | |
| ZrO₂ | 4.0 | 4.0 | 4.1 | 4.0 | 3.9 | 3.9 | 3.9 | 3.9 | 4.0 | 3.9 |
| ZnO | | | 2.7 | 0.4 | | | | | 3.1 | |
| Sb₂O₃ | | 0.2 | 0.2 | | 0.2 | | | 0.2 | 0.2 | 0.2 |
| Total | 100 | 100 | 100 | 100 | 100 | 100 | 100 | 100 | 100 | 100 |
| R₂O | 11.2 | 12.2 | 12.7 | 11.2 | 13.3 | 13.4 | 10.5 | 12.2 | 11.4 | 13.4 |
| Li₂O/R₂O | 0.43 | 0.34 | 0.34 | 0.34 | 0.26 | 0.26 | 0.26 | 0.26 | 0.27 | 0.26 |
| Melting temperature [° C.] | 1200 | 1200 | 1200 | 1200 | 1200 | 1200 | 1200 | 1200 | 1200 | 1200 |

TABLE 1-2

| | | | | | | | | | | Exam. |
|---|---|---|---|---|---|---|---|---|---|---|
| | Exam. 1 | Exam. 2 | Exam. 3 | Exam. 4 | Exam. 5 | Exam. 6 | Exam. 7 | Exam. 8 | Exam. 9 | 10 |
| Refractive index (n_{d}) | 1.78 | 1.76 | 1.74 | 1.76 | 1.76 | 1.76 | 1.76 | 1.76 | 1.76 | 1.76 |
| Density (d) [g/cm³] | 3.27 | 3.28 | 3.31 | 3.32 | 3.24 | 3.26 | 3.25 | 3.33 | 3.33 | 3.26 |
| Devitrification temperature [° C.] | 1025 | 990 | 1000 | 1050 | 1020 | 1020 | 1050 | 1125 | 1050 | 1020 |
| Temperature T₂ [° C.] | 1003 | 1016 | 1025 | 1013 | 1041 | 1045 | 1027 | 1064 | 1047 | 1062 |
| Light transmittance (T₃₆₀) [%] | 72 | | 75 | | | | | 72 | | 77 |
| Glass transition point (Tg) [° C.] | 576 | 572 | 556 | 584 | 583 | 586 | 611 | 591 | 597 | 589 |
| Young's modulus (E) [Gpa] | 103 | | 99 | | | | | 103 | | 98 |
| Water resistance (RW) | | | | | | | | | | 1 |
| Acid resistance (RA) | | | | | | | | | | 1 |
| Abbe number (v_{d}) | 31 | 31 | 31 | 32 | 32 | 32 | 32 | 33 | 34 | 33 |
| Thermal expansion coefficient α | 84 | 82 | 79 | 80 | 88 | 87 | 75 | 86 | 81 | 87 |
| (50-350° C.) [1/K] | | | | | | | | | | |

TABLE 2-1

| | Exam. | Exam. | Exam. | Exam. | Exam. | Exam. | Exam. | Exam. | Exam. | Exam. |
|---|---|---|---|---|---|---|---|---|---|---|
| | 11 | 12 | 13 | 14 | 15 | 16 | 17 | 18 | 19 | 20 |
| SiO₂ | 35.6 | 33.9 | 36.7 | 36.0 | 37.0 | 38.2 | 37.2 | 37.2 | 37.0 | 37.1 |
| B₂O₃ | 1.9 | 1.8 | 0.8 | 0.7 | 0.8 | 0.8 | 0.8 | 0.8 | 0.8 | 0.8 |
| MgO | | | | | | | | | | |
| CaO | | | | | | | | | | |
| SrO | | | | | | | | | | |
| BaO | | | | | | | | | | |
| Li₂O | 2.9 | 3.1 | 3.2 | 2.4 | 2.7 | 2.4 | 2.7 | 2.7 | 2.6 | 2.5 |
| Na₂O | 4.7 | 4.9 | 5.2 | 3.9 | 4.4 | 3.9 | 4.3 | 4.4 | 3.9 | 4.1 |
| K₂O | 3.1 | 3.2 | 3.4 | 5.4 | 4.3 | 3.8 | 4.3 | 4.3 | 4.7 | 4.0 |
| Al₂O₃ | | | | | | | | | | |
| Y₂O₃ | | | | | | | | | | |
| TiO₂ | | | 2.2 | | 3.4 | 3.0 | 3.0 | 3.8 | 3.5 | 3.1 |
| WO₃ | | | | | | | | | | |
| Nb₂O₅ | 41.3 | 39.1 | 41.3 | 44.6 | 42.3 | 43.0 | 42.4 | 42.4 | 41.9 | 41.5 |
| La₂O₃ | | 6.8 | | | | | | | | |
| ZrO₂ | 4.0 | 3.2 | 3.4 | 3.2 | 2.7 | 2.7 | 3.1 | 2.0 | 2.7 | 2.7 |
| ZnO | 6.5 | 3.8 | 3.6 | 3.8 | 2.2 | 2.2 | 2.2 | 2.2 | 2.7 | 4.0 |
| Sb₂O₃ | | 0.2 | 0.2 | | 0.2 | | | 0.2 | 0.2 | 0.2 |
| Total | 100 | 100 | 100 | 100 | 100 | 100 | 100 | 100 | 100 | 100 |
| R₂O | 10.8 | 11.1 | 11.8 | 11.7 | 11.4 | 10.1 | 11.3 | 11.4 | 11.2 | 10.6 |
| Li₂O/R₂O | 0.27 | 0.27 | 0.27 | 0.20 | 0.24 | 0.24 | 0.24 | 0.24 | 0.24 | 0.24 |
| Melting temperature [° C.] | 1200 | 1200 | 1200 | 1200 | 1200 | 1200 | 1200 | 1200 | 1200 | 1200 |

TABLE 2-2

| | Exam. | Exam. | Exam. | Exam. | Exam. | Exam. | Exam. | Exam. | Exam. | Exam. |
|---|---|---|---|---|---|---|---|---|---|---|
| | 11 | 12 | 13 | 14 | 15 | 16 | 17 | 18 | 19 | 20 |
| Refractive index (n_{d}) | 1.76 | 1.76 | 1.75 | 1.75 | 1.76 | 1.77 | 1.77 | 1.77 | 1.76 | 1.76 |
| Density (d) [g/cm³] | 3.36 | 3.40 | 3.25 | 3.27 | 3.23 | 3.29 | 3.29 | 3.27 | 3.22 | 3.24 |
| Devitrification temperature [° C.] | 1125 | 1150 | 1010 | 1060 | 1040 | 1150 | 1070 | 1070 | 1040 | 1070 |
| Temperature T₂ [° C.] | 1054 | 1043 | 1070 | 1096 | 1094 | 1118 | 1096 | 1090 | 1098 | 1095 |
| Light transmittance (T₃₆₀) [%] | | 75 | | | | | | | 66 | |
| Glass transition point (Tg) [° C.] | 599 | 595 | 597 | 618 | 615 | 633 | 616 | 614 | 618 | 620 |
| Young's modulus (E) [Gpa] | | 103 | | | | | | | 100 | |
| Water resistance (RW) | | | | | | | | | | |
| Acid resistance (RA) | | | | | | | | | | |
| Abbe number (v_{d}) | 34 | 35 | 33 | 34 | 33 | 33 | 33 | 32 | 33 | 33 |
| Thermal expansion coefficient α | 76 | 83 | 80 | 76 | 77 | 72 | 77 | 77 | 76 | 74 |
| (50-350° C.) [1/K] | | | | | | | | | | |

TABLE 3-1

| | Exam. | Exam. | Exam. | Exam. | Exam. | Exam. | Exam. | Exam. | Exam. | Exam. |
|---|---|---|---|---|---|---|---|---|---|---|
| | 21 | 22 | 23 | 24 | 25 | 26 | 27 | 28 | 29 | 30 |
| SiO₂ | 37.7 | 36.6 | 36.9 | 30.3 | 30.3 | 30.4 | 32.5 | 30.9 | 36.5 | 48.5 |
| B₂O₃ | 0.8 | 0.7 | 0.7 | 4.8 | 6.5 | 2.6 | 4.9 | 8.0 | 0.4 | |
| MgO | | | | 0.4 | 1.1 | 1.3 | | | | |
| CaO | | | | | | | | | 2.5 | 1.5 |
| SrO | | | | 0.5 | 2.3 | 0.6 | | 5.9 | 7.0 | |
| BaO | | | | | | | | | | |
| Li₂O | 2.5 | 3.0 | 2.9 | 4.0 | 4.4 | 4.3 | 4.8 | 1.7 | 3.4 | 5.2 |
| Na₂O | 4.0 | 4.7 | 4.7 | 7.2 | 4.8 | 5.3 | 5.4 | 5.7 | 4.9 | 0.8 |
| K₂O | 4.0 | 4.7 | 3.8 | 1.0 | 1.0 | 1.0 | 1.0 | 3.2 | 5.3 | 7.6 |
| Al₂O₃ | | | | | 2.2 | 1.6 | | | | |
| Y₂O₃ | | | | | | | | | | |
| TiO₂ | 3.5 | | | | | | | | | 9.7 |
| WO₃ | | | | 9.8 | | 8.7 | | 1.3 | | |
| Nb₂O₅ | 40.8 | 46.2 | 45.2 | 39.4 | 39.5 | 37.0 | 47.4 | 23.0 | 39.1 | 21.5 |
| La₂O₃ | | | | | 3.6 | 1.7 | | 3.7 | | |
| ZrO₂ | 2.7 | 3.9 | 3.9 | 2.6 | 4.1 | 3.3 | 4.0 | 7.1 | 0.7 | 5.0 |
| ZnO | 4.0 | | 1.7 | | | 2.2 | | 9.3 | | |
| Sb₂O₃ | | 0.2 | 0.2 | | 0.2 | | | 0.2 | 0.2 | 0.2 |
| Total | 100 | 100 | 100 | 100 | 100 | 100 | 100 | 100 | 100 | 100 |
| R₂O | 10.6 | 12.4 | 11.4 | 12.2 | 10.3 | 10.6 | 11.2 | 10.6 | 13.6 | 13.7 |
| Li₂O/R₂O | 0.24 | 0.24 | 0.25 | 0.32 | 0.43 | 0.41 | 0.43 | 0.16 | 0.25 | 0.38 |
| Melting temperature [° C.] | 1200 | 1200 | 1200 | 1200 | 1200 | 1200 | 1200 | 1200 | 1200 | 1200 |

TABLE 3-2

| | Exam. | Exam. | Exam. | Exam. | Exam. | Exam. | Exam. | Exam. | Exam. | Exam. |
|---|---|---|---|---|---|---|---|---|---|---|
| | 21 | 22 | 23 | 24 | 25 | 26 | 27 | 28 | 29 | 30 |
| Refractive index (n_{d}) | 1.75 | 1.76 | 1.76 | 1.76 | 1.75 | 1.76 | 1.77 | 1.70 | 1.73 | 1.70 |
| Density (d) [g/cm³] | 3.23 | 3.26 | 3.30 | 3.36 | 3.26 | 3.42 | 3.27 | 3.41 | 3.25 | 2.98 |
| Devitrification temperature [° C.] | 1080 | 1050 | 1050 | 1000 | 1125 | 1075 | 1050 | 1150 | 1125 | 1050 |
| Temperature T₂ [° C.] | 1097 | 1102 | 1100 | 958 | 969 | 988 | 979 | 973 | 1024 | 1173 |
| Light transmittance (T₃₆₀) [%] | | | | | | | | | 79 | 69 |
| Glass transition point (Tg) [° C.] | 620 | 611 | 615 | 552 | 573 | 562 | 571 | 580 | 577 | 589 |
| Young's modulus (E) [Gpa] | | | | | | | | | 104 | 101 |
| Water resistance (RW) | | | | | | | | 1 | | 1 |
| Acid resistance (RA) | | | | | | | | 1 | | 1 |
| Abbe number (v_{d}) | 33 | 33 | 33 | 28 | 33 | 28 | 31 | 38 | 39 | 38 |
| Thermal expansion coefficient α | 74 | 81 | 78 | 77 | 86 | 77 | 84 | 80 | 92 | 83 |
| (50-350° C.) [1/K] | | | | | | | | | | |

TABLE 4-1

| | Exam. | Exam. | Exam. | Exam. | Exam. | Exam. | Exam. | Exam. | Exam. | Exam. |
|---|---|---|---|---|---|---|---|---|---|---|
| | 31 | 32 | 33 | 34 | 35 | 36 | 37 | 38 | 39 | 40 |
| SiO₂ | 45.9 | 30.7 | 29.2 | 38.4 | 36.8 | 36.6 | 34.2 | 38.0 | 36.6 | 36.3 |
| B₂O₃ | | 1.4 | 0.3 | 3.4 | 1.8 | 0.9 | 0.9 | 0.9 | 0.9 | 0.9 |
| MgO | | 0.4 | | | 5.2 | 3.1 | 2.5 | 2.6 | 3.1 | 4.7 |
| CaO | | | | 6.9 | | 3.7 | 2.4 | 3.2 | 3.6 | 3.7 |
| SrO | 2.7 | | | | | 5.4 | 13.1 | 4.0 | 5.3 | 5.4 |
| BaO | 4.0 | | | | | 7.9 | 7.7 | 5.9 | 7.8 | 7.9 |
| Li₂O | 6.3 | 3.6 | 2.7 | 3.3 | 3.1 | 1.5 | 1.5 | 1.5 | 0.8 | 0.8 |
| Na₂O | 1.6 | 8.1 | 4.2 | 3.8 | 4.8 | 2.4 | 2.3 | 2.4 | 1.6 | 1.6 |
| K₂O | 6.2 | | 4.3 | 4.6 | 4.9 | 1.2 | 1.2 | 1.2 | 1.2 | 1.2 |
| Al₂O₃ | | | | | | | | | | |
| Y₂O₃ | | | | | | | | | | |
| TiO₂ | 7.3 | | | | | 7.2 | 8.1 | 7.1 | 7.1 | 7.2 |
| WO₃ | | 4.7 | | | | | | | | |
| Nb₂O₅ | 24.4 | 50.9 | 53.3 | 32.6 | 27.4 | 20.6 | 16.8 | 23.7 | 20.4 | 20.6 |
| La₂O₃ | | | | | | | | | | |
| ZrO₂ | 1.6 | | 3.5 | 3.0 | 3.2 | 3.2 | 3.1 | 3.1 | 3.1 | 3.2 |
| ZnO | | | 2.3 | 4.0 | 12.6 | 6.3 | 6.2 | 6.2 | 8.3 | 6.3 |
| Sb₂O₃ | | 0.2 | 0.2 | | 0.2 | | | 0.2 | 0.2 | 0.2 |
| Total | 100 | 100 | 100 | 100 | 100 | 100 | 100 | 100 | 100 | 100 |
| R₂O | 14.1 | 11.7 | 11.3 | 11.7 | 12.7 | 5.2 | 5.0 | 5.1 | 3.5 | 3.6 |
| Li₂O/R₂O | 0.45 | 0.31 | 0.24 | 0.28 | 024 | 0.30 | 0.30 | 0.30 | 0.22 | 0.22 |
| Melting temperature [° C.] | 1200 | 1200 | 1200 | 1200 | 1200 | 1200 | 1200 | 1200 | 1200 | 1200 |

TABLE 4-2

| | Exam. | Exam. | Exam. | Exam. | Exam. | Exam. | Exam. | Exam. | Exam. | Exam. |
|---|---|---|---|---|---|---|---|---|---|---|
| | 31 | 32 | 33 | 34 | 35 | 36 | 37 | 38 | 39 | 40 |
| Refractive index (n_{d}) | 1.69 | 1.80 | 1.83 | 1.72 | 1.71 | 1.76 | 1.76 | 1.76 | 1.76 | 1.76 |
| Density (d) [g/cm³] | 3.04 | 3.41 | 3.52 | 3.22 | 3.32 | 3.50 | 3.57 | 3.46 | 3.56 | 3.54 |
| Devitrification temperature [° C.] | 1025 | 1100 | 1100 | 1175 | 1100 | 1100 | 1100 | 1175 | 1175 | 1150 |
| Temperature T₂ [° C.] | 1108 | 958 | 1020 | 1053 | 1018 | 1069 | 1018 | 1093 | 1089 | 1086 |
| Light transmittance (T₃₆₀) [%] | 76 | 66 | 66 | 81 | 81 | | | | | |
| Glass transition point (Tg) [° C.] | 557 | 571 | 613 | 584 | 569 | 631 | 622 | 641 | 651 | 654 |
| Young's modulus (E) [Gpa] | 102 | 108 | 105 | 109 | 106 | | | | | |
| Water resistance (RW) | | | 1 | | 1 | | | | | |
| Acid resistance (RA) | | | 1 | | 1 | | | | | |
| Abbe number (v_{d}) | 37 | 27 | 28 | 42 | 33 | 37 | 38 | 36 | 37 | 36 |
| Thermal expansion coefficient α | 91 | 82 | 80 | 83 | 83 | 75 | 80 | 71 | 68 | 70 |
| (50-350° C.) [1/K] | | | | | | | | | | |

TABLE 5-1

| | Exam. | Exam. | Exam. | Exam. | Exam. | Exam. | Exam. | Exam. |
|---|---|---|---|---|---|---|---|---|
| | 41 | 42 | 43 | 44 | 45 | 46 | 47 | 48 |
| SiO₂ | 35.0 | 32.7 | 33.4 | 31.7 | 31.7 | 33.9 | 35.1 | 34.0 |
| B₂O₃ | 0.9 | 0.9 | 0.9 | 0.8 | 0.8 | 0.8 | 0.7 | 0.7 |
| MgO | 3.0 | 3.5 | 3.0 | 2.8 | 2.9 | | | |
| CaO | 5.6 | 5.5 | 5.6 | 5.2 | 5.3 | 5.4 | | |
| SrO | 2.6 | 2.5 | 2.6 | 2.4 | 2.4 | 12.4 | | |
| BaO | 7.6 | 7.5 | 7.6 | 7.1 | 7.2 | 3.7 | | |
| Li₂O | 0.7 | 1.1 | 1.1 | 1.0 | 1.1 | 0.7 | 2.5 | 2.9 |
| Na₂O | 1.5 | 2.3 | 2.3 | 2.2 | 2.2 | 1.5 | 3.9 | 4.5 |
| K₂O | 1.2 | 1.2 | 1.2 | 1.1 | 1.1 | 1.1 | 4.0 | 4.5 |
| Al₂O₃ | | | | | | | | |
| Y₂O₃ | | | | | | | | |
| TiO₂ | 9.9 | 7.8 | 10.0 | 7.4 | 6.6 | 9.6 | 2.5 | |
| WO₃ | | | | | 8.2 | | | |
| Nb₂O₅ | 19.8 | 22.8 | 19.9 | 15.5 | 18.8 | 19.1 | 44.6 | 49.7 |
| La₂O₃ | | | | 11.4 | | | | |
| ZrO₂ | 3.1 | 3.0 | 3.1 | 2.9 | 2.9 | 3.0 | 3.9 | 3.7 |
| ZnO | 9.1 | 9.0 | 9.1 | 8.5 | 8.6 | 8.8 | 2.6 | |
| Sb₂O₃ | | 0.2 | 0.2 | | 0.2 | | 0.2 | |
| Total | 100 | 100 | 100 | 100 | 100 | 100 | 100 | 100 |
| R₂O | 3.5 | 4.5 | 4.6 | 4.3 | 4.4 | 3.3 | 10.4 | 11.9 |
| Li₂O/R₂O | 0.22 | 0.24 | 0.24 | 0.24 | 0.24 | 0.22 | 0.24 | 0.24 |
| Melting temperature [° C.] | 1200 | 1200 | 1200 | 1200 | 1200 | 1200 | 1200 | 1200 |

TABLE 5-2

| | Exam. | Exam. | Exam. | Exam. | Exam. | Exam. | Exam. | Exam. |
|---|---|---|---|---|---|---|---|---|
| | 41 | 42 | 43 | 44 | 45 | 46 | 47 | 48 |
| Refractive index (n_{d}) | 1.78 | 1.78 | 1.78 | 1.78 | 1.78 | 1.78 | 1.77 | 1.78 |
| Density (d) [g/cm³] | 3.58 | 3.61 | 3.58 | 3.71 | 3.68 | 3.63 | 3.28 | 3.30 |
| Devitrification temperature [° C.] | 1175 | 1125 | 1090 | 1125 | 1125 | 1100 | 1075 | 1075 |
| Temperature T₂ [° C.] | 1073 | 1041 | 1045 | 1036 | 1048 | 1024 | 1092 | 1078 |
| Light transmittance (T₃₆₀) [%] | | | | | | | | |
| Glass transition point (Tg) [° C.] | 648 | 634 | 632 | 632 | 628 | 646 | 627 | 615 |
| Young's modulus (E) [Gpa] | | | 115 | 113 | | 111 | | |
| Water resistance (RW) | | | | 1 | | | | |
| Acid resistance (RA) | | | | 1 | | | | |
| Abbe number (v_{d}) | 36 | 36 | 36 | 39 | 33 | 41 | 31 | 31 |
| Thermal expansion coefficient α | 69 | 73 | 74 | 79 | 63 | 70 | 74 | 80 |
| (50-350° C.) [1/K] | | | | | | | | |

TABLE 6-1

| | Exam. | Exam. | Exam. | Exam. | Exam. | Exam. | Exam. | Exam. |
|---|---|---|---|---|---|---|---|---|
| | 49 | 50 | 51 | 52 | 53 | 54 | 55 | 56 |
| SiO₂ | 34.5 | 33.9 | 34.0 | 36.0 | 33.5 | 34.4 | 34.4 | 34.2 |
| B₂O₃ | 0.4 | 0.4 | 0.4 | 0.4 | 0.3 | 0.4 | 0.4 | |
| MgO | | | | | | | | |
| CaO | | | | | | | | |
| SrO | | | | | | | | |
| BaO | | | | | | | | |
| Li₂O | 3.0 | 3.0 | 2.9 | 3.2 | 3.0 | 3.1 | 3.1 | 3.2 |
| Na₂O | 4.4 | 4.3 | 4.2 | 4.6 | 4.3 | 4.5 | 4.5 | 4.3 |
| K₂O | 4.3 | 4.4 | 4.3 | 4.6 | 4.3 | 4.5 | 4.5 | 4.4 |
| Al₂O₃ | | | | | | | | |
| Y₂O₃ | | | | | | | | |
| TiO₂ | | | | | | | | |
| WO₃ | | | | | | | | |
| Nb₂O₅ | 50.3 | 50.1 | 49.0 | 47.3 | 44.2 | 49.3 | 48.9 | 50.2 |
| La₂O₃ | | | | | 6.5 | | | |
| ZrO₂ | 3.1 | 3.7 | 5.0 | 3.9 | 3.7 | 3.8 | 4.0 | 3.7 |
| ZnO | | | | | | | | |
| Sb₂O₃ | | 0.2 | 0.2 | | 0.2 | | 0.2 | |
| Total | 100 | 100 | 100 | 100 | 100 | 100 | 100 | 100 |
| R₂O | 11.7 | 11.7 | 11.4 | 12.4 | 11.6 | 12.1 | 12.1 | 11.9 |
| Li₂O/R₂O | 0.26 | 0.26 | 0.26 | 0.26 | 0.26 | 0.26 | 0.26 | 0.27 |
| Melting temperature [° C.] | 1200 | 1200 | 1200 | 1200 | 1200 | 1200 | 1200 | 1200 |

TABLE 6-2

| | Exam. | Exam. | Exam. | Exam. | Exam. | Exam. | Exam. | Exam. |
|---|---|---|---|---|---|---|---|---|
| | 49 | 50 | 51 | 52 | 53 | 54 | 55 | 56 |
| Refractive index (n_{d}) | 1.78 | 1.78 | 1.78 | 1.77 | 1.77 | 1.78 | 1.78 | 1.79 |
| Density (d) [g/cm³] | 3.31 | 3.32 | 3.32 | 3.30 | 3.40 | 3.33 | 3.33 | 3.35 |
| Devitrification temperature [° C.] | 1065 | 1065 | 1100 | 1050 | 1175 | 1065 | 1055 | 1100 |
| Temperature T₂ [° C.] | 1079 | 1080 | 1094 | 1094 | 1079 | 1080 | 1082 | 1079 |
| Light transmittance (T₃₆₀) [%] | | | | | | | | |
| Glass transition point (Tg) [° C.] | 615 | 616 | 621 | 607 | 613 | 611 | 611 | 613 |
| Young's modulus (E) [Gpa] | | | | | | | | |
| Water resistance (RW) | | 1 | | | | | | |
| Acid resistance (RA) | | 1 | | | | | | |
| Abbe number (v_{d}) | 27 | 27 | 27 | 28 | 29 | 28 | 28 | 27 |
| Thermal expansion coefficient α | 79 | 80 | 79 | 82 | 84 | 81 | 81 | 81 |
| (50-350° C.) [1/K] | | | | | | | | |

TABLE 7-1

| | Exam. | Exam. | Exam. | Exam. | Exam. | Exam, | Exam. | Exam. | Exam. | Exam. |
|---|---|---|---|---|---|---|---|---|---|---|
| | 57 | 58 | 59 | 60 | 61 | 62 | 63 | 64 | 65 | 66 |
| SiO₂ | 28.8 | 9.5 | 5.4 | 28.9 | 20.0 | 31.3 | 37.6 | 21.0 | 52.9 | 23.43 |
| B₂O₃ | 4.6 | 21 | 14 | 2.2 | 6.8 | 2.4 | | | | 3.03 |
| MgO | 0.2 | | | 0.4 | | 0.5 | 3.0 | | | |
| CaO | | | | | | | 5.9 | 1.0 | | |
| SrO | 0.5 | | | | | 4.8 | 4.9 | | | |
| BaO | | | | | | | 27.0 | | | |
| Li₂O | 2.9 | 0.9 | | 5.8 | 10.0 | 5.7 | | 7.9 | 8.8 | 7.41 |
| Na₂O | 8.7 | | 3.7 | 5.3 | 5.0 | 3.6 | | 3.4 | 4.8 | 6.31 |
| K₂O | 0.9 | | | 1.0 | | 1.1 | | 1.0 | 1.5 | |
| Al₂O₃ | | | 4.5 | | | 2.4 | 1.5 | | | |
| Y₂O₃ | | | | | | | | 0.6 | | |
| TiO₂ | | | | | | | 6.7 | 4.0 | 7.4 | 3.15 |
| WO₃ | 10.5 | | 7.3 | 9.9 | | | | | | |
| Nb₂O₅ | 42.9 | | | 39.8 | 55.0 | 38.4 | 6.3 | 56.0 | 24.6 | 46.20 |
| La₂O₃ | | 20.2 | 31.4 | | | | 3.9 | | | |
| ZrO₂ | | 1.7 | 3.5 | 4.0 | 3.0 | 1.4 | 3.2 | 3.0 | | 8.48 |
| ZnO | | 24.6 | 15.3 | 2.6 | | 8.5 | | 2.0 | | 1.94 |
| Sb₂O₃ | | | | | | | | | | 0.04 |
| Total | 100 | 100 | 100 | 100 | 99.8 | 100 | 100 | 99.9 | 100 | 100 |
| R₂O | 12.6 | 0.9 | 3.7 | 12.1 | 15.0 | 10.4 | 0.0 | 12.3 | 15.0 | 13.7 |
| Li₂O/R₂O | 0.23 | 1.00 | 0.00 | 0.48 | 0.67 | 0.55 | — | 0.64 | 0.58 | 0.54 |
| Melting temperature [° C.] | 1200 | 1200 | 1200 | 1200 | 1200 | 1200 | 1400 | 1200 | 1200 | 1200 |

TABLE 7-2

| | Exam. | Exam. | Exam. | Exam. | Exam. | Exam. | Exam. | Exam. | Exam. | Exam. |
|---|---|---|---|---|---|---|---|---|---|---|
| | 57 | 58 | 59 | 60 | 61 | 62 | 63 | 64 | 65 | 66 |
| Refractive index (n_{d}) | 1.77 | 1.74 | 1.78 | 1.78 | 1.83 | 1.75 | 1.70 | 1.89 | 1.67 | 1.877 |
| Density (d) [g/cm³] | 3.41 | 4.44 | 4.65 | 3.46 | 3.41 | 3.38 | 3.66 | 3.62 | 2.86 | 3.97 |
| Devitrification temperature [° C.] | 1050 | | | 1075 | | 1075 | 1070 | 1400< | | |
| Temperature T₂ [° C.] | 933 | <950 | <950 | 937 | <950 | 927 | 1210 | | 1086 | <950 |
| Light transmittance (T₃₆₀) [%] | | | | | | | 64 | | | |
| Glass transition point (Tg) [° C.] | 556 | | | 529 | | 540 | | | | |
| Young's modulus (E) [Gpa] | | | | | 111 | | | 115 | 96 | |
| Water resistance (RW) | | | | | | | | | | |
| Acid resistance (RA) | | | | | | | | | | |
| Abbe number (v_{d}) | 26 | | | 26 | | 33 | | | | |
| Thermal expansion coefficient α | 77 | | | 80 | | 87 | | | | |
| (50-350° C.) [1/K] | | | | | | | | | | |

Each of the optical glasses of the examples (Examples 1 to 56) has the refractive index (n_{d}) as high as 1.68 or more. In addition, the density is as low as 4.0 g/cm³ or less. Further, the manufacturing properties are good because the temperature where the viscosity of the glass becomes log η=2 is 950 to 1200° C. Accordingly, it is suitable for the optical glass used for the wearable equipment, the vehicle-mounted camera, and the robot's visual sensor.

On the other hand, each of the glasses of Example 57 to Example 61 being the comparative examples contains less than 29% of Si02, and therefore, the manufacturing properties deteriorate because the temperature T₂ where log η=2 is lower than 950° C. In the glass of Example 62, since Li₂O/(Li₂O+Na₂O+K₂O) is larger than 0.45, the manufacturing properties deteriorate because the temperature T₂ where log η=2 is lower than 950° C. In the glass of Example 63, since Li₂O+Na₂O+K₂O is 2% or less, the temperature T₂ where log η=2 is higher than 1200° C. and the melting temperature is set at 1400° C. to enable clarifying and homogenizing of the glass, and therefore, the transmittance of light with the wavelength of 360 nm (T₃₆₀) when the sample is made into the glass plate with the thickness of 1 mm is low. Since the glass of Example 64 contains more than 55% of Nb₂O₅, the refractive index (n_{d}) is higher than 1.85, the devitrification temperature is higher than 1200° C., and the moldability deteriorates. Since the glass of Example 65 contains more than 50% of SiO₂, the refractive index (n_{d}) is lower than 1.68. Since the glass of Example 66 contains less than 29% of Si02, the temperature T₂ where log η=2 is lower than 950° C.

In the optical glasses obtained from the glasses where the glass compositions of the examples (Examples 1 to 56) are melted, there are included the glasses without any residual bubbles, and the glasses including one or two residual bubbles with a size of 14 μm to 54 μm. The aspect ratios (L₂/L₁) of the residual bubbles are almost 0.9 or more, and some of them are 1.0. Even in the optical glass including the residual bubbles, the size is small and the number of pieces is also small, and therefore, there can be obtained the glass plate without any defects such as bubbles, foreign matters, striae, phase separations. Accordingly, when the sample with the size as stated above is formed, it is possible to obtain the optical glass having the LTV value of 2 μm or less, the warpage value (the circular glass plate with the diameter of 6 inches) of 30 μm or less, and the Ra value of 2 nm or less. Further, the glass having the water resistance (RW) evaluation of Class 2 or higher, and the acid resistance (RA) evaluation of Class 1 or higher is able to avoid surface deterioration at polishing time and washing time, and therefore, it is thought that the LTV value of 1.5 μm or less, the warpage value (the circular glass plate with the diameter of 6 inches) of 18 μor less, and the Ra value of 1 nm or less can be obtained.

When three kinds of the glass plates of the examples without any defects were precisely polished, the LTV values of 1.1, 1.4, 1.3 μm, the warpage values of 45, 36, 42 μm, and the Ra values of 0.276, 0.358, 0.362 nm were obtained. Accordingly, the optical glass having the LTV value of 2 μm or less, the warpage value of 50 μor less, and the Ra value of 2 nm or less can be obtained by precisely polishing the glass plate without any defects of the example of this embodiment.

When the glass of this invention is chemically tempered, for example, the glass is immersed into melt where sodium nitrate salt is heated to 400° C. to be melted for 30 minutes to perform the chemical tempering treatment, and thereby the tempered glass can be obtained.

According to the above results, the optical glass of this embodiment has a high refractive index, a low density, and good manufacturing properties, and is suitable as the optical glass for the wearable equipment, for the vehicle mounting, for the robot mounting, and so on.

What is claimed is:

1. An optical glass, having:
a refractive index (n_{d}) of 1.68 to 1.85;
a density (d) of 4.0 g/cm³ or less; and
a temperature T₂ where a viscosity of glass becomes log η=2 of 950° C. to 1200° C.

2. The optical glass according to claim 1, containing, in percentage by mass based on oxides:
Nb₂O₅: 5% to 55%;
0% to 30% of at least one kind selected from a group consisting of BaO, TiO₂, ZrO₂, WO₃, and Ln₂O₃, where Ln is at least one kind selected from a group consisting of Y, La, Gd, Yb and Lu;
SiO₂: 29% to 50%; and
2% to 20% of Li₂O+Na₂O+K₂O,
wherein Li₂O/(Li₂O+Na₂O+K₂O) is 0.45 or less.

3. The optical glass according to claim 2, containing, in percentage by mass based on oxides:
B₂O₃: 0% to 10%;
MgO: 0% to 10%;
CaO: 0% to 15%;
SrO: 0% to 15%;
BaO: 0% to 15%;
Li₂O: 0% to 9%;
Na₂O: 0% to 10%;
K₂O: 0% to 10%;
Al₂O₃: 0% to 5%;
TiO₂: 0% to 15%;
WO₃: 0% to 15%;
ZrO₂: 0% to 15%;
ZnO: 0% to 15%; and
La₂O₃: 0% to 12%.

4. The optical glass according to claim 1,
wherein a devitrification temperature of the optical glass is 1200° C. or less.

5. The optical glass according to claim 1,
wherein transmittance of light with a wavelength of 360 nm (T₃₆₀) of a glass plate made of the optical glass with a thickness of 1 mm is 40% or more.

6. The optical glass according to claim 1,
wherein Young's modulus (E) of the optical glass is 60 GPa or more.

7. The optical glass according to claim 1,
wherein water resistance of the optical glass is Class 2 or higher, and acid resistance of the optical glass is Class 1 or higher each measured based on Japanese Optical Glass Industrial Standards.

8. The optical glass according to claim 1,
wherein a glass transition point (Tg) of the optical glass is 500° C. to 700° C., an Abbe number (v_{d}) of the optical glass is 50 or less, a thermal expansion coefficient α at 50° C. to 350° C. of the optical glass is 50×10⁻⁷/K to 150×10⁻⁷/K.

9. The optical glass according to claim 1,
wherein the optical glass is in a plate shape with a plate thickness of 0.01 mm to 2 mm.

10. The optical glass according to claim 1,
wherein an area of one principal surface of the optical glass is 8 cm² or more.

11. The optical glass according to claim 1,
wherein a local thickness variation when the optical glass is made into a glass plate whose area of one principal surface is 25 cm² and opposing principal surfaces of the optical glass are polished is 2μm or less.

12. The optical glass according to claim 1,
wherein warpage of one principal surface when the optical glass is made into a circular glass plate with a diameter of 8 inches is 50 μm or less.

13. The optical glass according to claim 1,
wherein surface roughness Ra of the optical glass is 2 nm or less.

14. An optical component, comprising the plate-shaped optical glass according to claim 9.

15. The optical component according to claim 14,
wherein an anti-reflection film is provided on a surface of the plate-shaped optical glass.
